(19) United States
(12) Patent Application Publication
(10) Pub. No.: US 2015/0023449 A1
(43) Pub. Date: Jan. 22, 2015

(54) Distributed signal fields (SIGs) for use in wireless communications

(71) Applicant: BROADCOM CORPORATION, Irvine, CA (US)

(72) Inventors: Ron Porat, San Diego, CA (US); Nihar Jindal, San Francisco, CA (US)

(73) Assignee: BROADCOM CORPORATION, IRVINE, CA (US)

(21) Appl. No.: 14/510,313

(22) Filed: Oct. 9, 2014

Related U.S. Application Data
(63) Continuation-in-part of application No. 14/041,225, filed on Sep. 30, 2013.
(60) Provisional application No. 61/888,967, filed on Oct. 9, 2013.
(60) Provisional application No. 61/898,211, filed on Oct. 31, 2013.
(60) Provisional application No. 61/751,401, filed on Jan. 11, 2013.
(60) Provisional application No. 61/831,789, filed on Jun. 6, 2013.
(60) Provisional application No. 61/870,606, filed on Aug. 27, 2013.
(60) Provisional application No. 61/873,512, filed on Sep. 4, 2013.

(51) Int. Cl. H04L 27/26; H04L 5/00

(52) U.S. Cl. CPC H04L 27/2626; H04L 5/0048
USPC 375/295

(57) ABSTRACT

A wireless communication device includes a communication interface and a processor and is configured to generate a preamble of an OFDM packet that includes signal fields (SIGs) that specify first characteristics of a remainder of the OFDM packet that follows the SIG fields. A first at least one SIG includes information to specify second characteristics of a second at least one SIG that follows the first at least one SIG. The wireless communication device then transmits the OFDM packet to another wireless communication device. The second characteristics specifies any number of characteristics including any one or more of a size of a GI between the first at least one SIG and the second at least one SIG, a MCS used to generate the second at least one SIG, a length of the second at least one SIG, or a number of OFDM symbols of the second at least one SIG.

### CROSS REFERENCE TO RELATED PATENTS/PATENT APPLICATIONS

### Provisional Priority Claims

The present U.S. Utility patent application claims priority pursuant to 35 U.S.C. §119(e) to U.S. Provisional Application No. 61/888,967, entitled “Next generation within single user, multiple user, multiple access, and/or MIMO wireless communications,” filed 10-09-2013; and U.S. Provisional Application No. 61/898,211, entitled “Next generation within single user, multiple user, multiple access, and/or MIMO wireless communications,” filed 10-31-2013, both of which are hereby incorporated herein by reference in their entirety and made part of the present U.S. Utility patent application for all purposes.

### Continuation-in-Part (CIP) Priority Claim, 35 U.S.C. §120

The present U.S. Utility patent application also claims priority pursuant to 35 U.S.C. §120, as a continuation-in-part (CIP), to the following U.S. Utility patent application which is hereby incorporated herein by reference in its entirety and made part of the present U.S. Utility patent application for all purposes, U.S. Utility patent application Ser. No. 14/041,225, entitled “Orthogonal frequency division multiple access (OFDMA) and duplication signaling within wireless communications,” filed Sep. 30, 2013, pending, which claims priority pursuant to 35 U.S.C. §119(e) to U.S. Provisional Patent Application No. 61/751,401, entitled “Next generation within single user, multiple user, multiple access, and/or MIMO wireless communications,” filed Jan. 11, 2013; U.S. Provisional Patent Application No. 61/831,789, entitled “Next generation within single user, multiple user, multiple access, and/or MIMO wireless communications,” filed Jun. 6, 2013; U.S. Provisional Patent Application No. 61/870,606, entitled “Next generation within single user, multiple user, multiple access, and/or MIMO wireless communications,” filed Aug. 27, 2013; U.S. Provisional Patent Application No. 61/873,512, entitled “Orthogonal frequency division multiple access (OFDMA) and duplication signaling within wireless communications,” filed Sep. 4, 2013; all of which are hereby incorporated herein by reference in their entirety and made part of the present U.S. Utility patent application for all purposes.

### BACKGROUND

1. Technical Field

The present disclosure relates generally to communication systems; and, more particularly, to packet (or frame) generation and processing within single user, multiple user, multiple access, and/or MIMO wireless communications.

2. Description of Related Art

Communication systems support wireless and wire lined communications between wireless and/or wire lined communication devices. The systems can range from national and/or international cellular telephone systems, to the Internet, to point-to-point in-home wireless networks and can operate in accordance with one or more communication standards. For example, wireless communication systems may operate in accordance with one or more standards including, but not limited to, IEEE 802.11x (where x may be various extensions such as a, b, n, g, etc.), Bluetooth, advanced mobile phone services (AMPS), digital AMPS, global system for mobile communications (GSM), etc., and/or variations thereof.

In some instances, wireless communication is made between a transmitter (TX) and receiver (RX) using single-input-single-output (SISO) communication. Another type of wireless communication is single-input-multiple-output (SIMO) in which a single TX processes data into radio frequency (RF) signals that are transmitted to a RX that includes two or more antennae and two or more RX paths.

Yet an alternative type of wireless communication is multiple-input-single-output (MISO) in which a TX includes two or more transmission paths that each respectively converts a corresponding portion of baseband signals into RF signals, which are transmitted via corresponding antennae to a RX. Another type of wireless communication is multiple-input-multiple-output (MIMO) in which a TX and RX each respectively includes multiple paths such that a TX parallel processes data using a spatial and time encoding function to produce two or more streams of data and a RX receives the multiple RF signals via multiple RX paths that recapture the streams of data utilizing a spatial and time decoding function.

Within certain communication systems, some communications include various types of fields. With the advent of new applications and implementations of such communication systems, there continues to be in need in the art to specify different types of frame formats, field formats, etc. for such communications. Particularly with the development of new communication standards, protocols, and/or recommended practices, there continues to be a need in the art to address new and different applications and implementations. As such, there is a need in the art to provide signaling related solutions to address such problems.

### BRIEF DESCRIPTION OF THE SEVERAL VIEWS OF THE DRAWINGS

FIG. 1 is a diagram illustrating an embodiment of a wireless communication system.

FIG. 2 is a diagram illustrating an embodiment of dense deployment of wireless communication devices.

FIG. 3A is a diagram illustrating an example of communication between wireless communication devices.

FIG. 3B is a diagram illustrating another example of communication between wireless communication devices.

FIG. 3C is a diagram an example of at least one portion of an orthogonal frequency division multiplexing (OFDM) packet that includes distributed signal field (SIG) information.

FIG. 4A is a diagram illustrating an example of orthogonal frequency division multiplexing (OFDM) and/or orthogonal frequency division multiple access (OFDMA).

FIG. 4B is a diagram illustrating another example of OFDM and/or OFDMA.

FIG. 4C is a diagram illustrating another example of OFDM and/or OFDMA.

FIG. 4D is a diagram illustrating another example of OFDM and/or OFDMA.

FIG. 5A is a diagram illustrating an example of an OFDM/A packet.

FIG. 5B is a diagram illustrating another example of an OFDM/A packet of a second type.

FIG. 5C is a diagram illustrating an example of at least one portion of an OFDM/A packet of another type.

FIG. 5D is a diagram illustrating another example of at least one portion of an OFDM/A packet of another type.

FIG. 5E is a diagram illustrating another example of at least one portion of an OFDM/A packet of another type.

FIG. 5F is a diagram illustrating another example of at least one portion of an OFDM/A packet of another type.

FIG. 6A is a diagram illustrating an example of a preamble of an OFDM/A packet tailored for extended range and/or lower rate applications.

FIG. 6B is a diagram illustrating another example of a preamble of an OFDM/A packet tailored for extended range and/or lower rate applications.

FIG. 6C is a diagram illustrating another example of a preamble of an OFDM/A packet tailored for extended range and/or lower rate applications.

FIG. 7A is a diagram illustrating another example of a preamble of an OFDM/A packet tailored for extended range and/or lower rate applications.

FIG. 7B is a diagram illustrating another example of a preamble of an OFDM/A packet tailored for extended range and/or lower rate applications.

FIG. 7C is a diagram illustrating another example of at least one portion of an OFDM/A packet of another type.

FIG. 7D is a diagram illustrating another example of at least one portion of an OFDM/A packet of another type.

FIG. 8A is a diagram illustrating an example of SIG information modulated on a contiguous set of sub-carriers (SCs) within a set of OFDM/A sub-carriers for a first at least one signal field (SIG) (e.g., first at least one SIG).

FIG. 8B is a diagram illustrating another example of SIG information modulated on all sub-carriers of a contiguous set of SCs within a set of OFDM/A sub-carriers for at least one SIG (e.g., second at least one SIG).

FIG. 8C is a diagram illustrating an example of SIG information modulated on only even (or odd) sub-carriers (SCs) a contiguous set of sub-carriers (SCs) within a set of OFDM/A sub-carriers (e.g., first at least one SIG).

FIG. 8D is a diagram illustrating an example of SIG information modulated on only even (or odd) sub-carriers (SCs) of all sub-carriers of a contiguous set of SCs within a set of OFDM/A sub-carriers for at least one SIG (e.g., second at least one SIG).

FIG. 9A is a diagram illustrating another example of at least one portion of an OFDM/A packet of another type.

FIG. 9B is a diagram illustrating another example of at least one portion of an OFDM/A packet of another type.

FIG. 9C is a diagram illustrating another example of at least one portion of an OFDM/A packet of another type.

FIG. 9D is a diagram illustrating an example of different types of modulations or modulation coding sets (MCSs) used for modulation of information within different fields within an OFDM/A packet.

FIG. 9E is a diagram illustrating an example of different types of transmission (TX) power used for different sub-carriers within at least one OFDM/A symbol of at least one OFDM/A packet.

FIG. 9F is a diagram illustrating an example of similar transmission (TX) power used for different sub-carriers within at least one OFDM/A symbol of at least one OFDM/A packet.

FIG. 9G is a diagram illustrating an example of separate encoding operations to generate different SIGs.

FIG. 9H is a diagram illustrating another example of separate encoding operations to generate different SIGs.

FIG. 10A is a diagram illustrating an embodiment of a method for execution by at least one wireless communication device.

FIG. 10B is a diagram illustrating another embodiment of a method for execution by at least one wireless communication device.

FIG. 10C is a diagram illustrating another embodiment of a method for execution by at least one wireless communication device.

### DETAILED DESCRIPTION

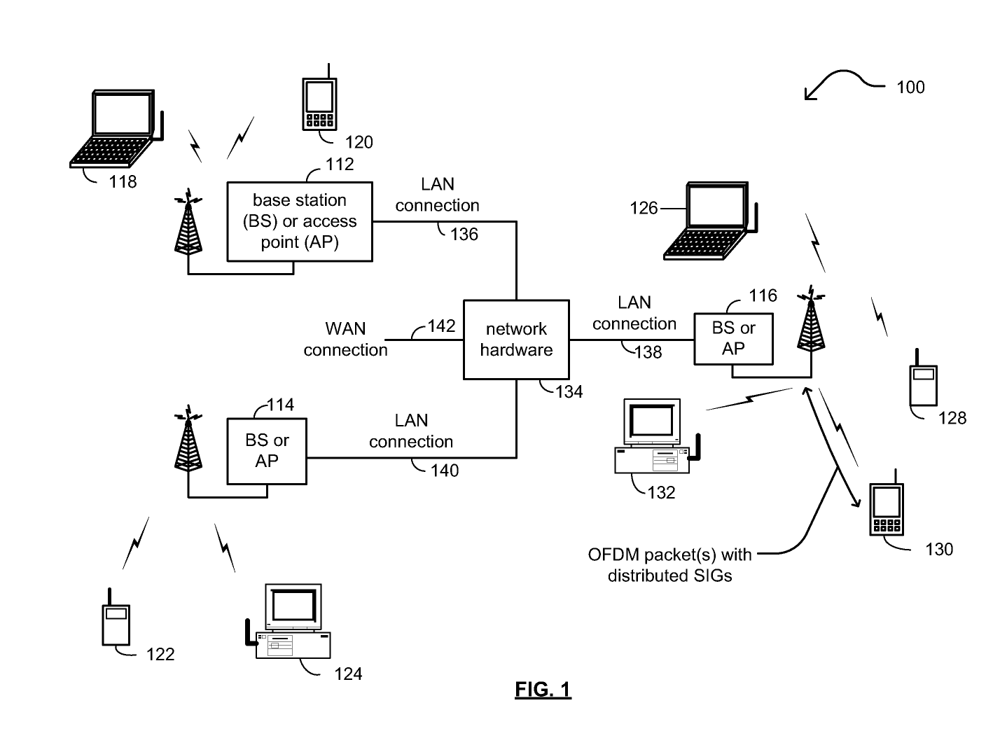

FIG. 1 is a diagram illustrating an embodiment of a wireless communication system 100. The wireless communication system 100 includes base stations and/or access points 112-116, wireless communication devices 118-132 (e.g., wireless stations (STAs)), and a network hardware component 134. The wireless communication devices 118-132 may be laptop computers, or tablets, 118 and 126, personal digital assistants 120 and 130, personal computers 124 and 132 and/or cellular telephones 122 and 128. The details of an embodiment of such wireless communication devices are described in greater detail with reference to FIG. 2.

The base stations (BSs) or access points (APs) 112-116 are operably coupled to the network hardware 134 via local area network connections 136, 138, and 140. The network hardware 134, which may be a router, switch, bridge, modem, system controller, etc., provides a wide area network connection 142 for the communication system 100. Each of the base stations or access points 112-116 has an associated antenna or antenna array to communicate with the wireless communication devices in its area. Typically, the wireless communication devices register with a particular base station or access point 112-116 to receive services from the communication system 100. For direct connections (i.e., point-to-point communications), wireless communication devices communicate directly via an allocated channel.

Any of the various wireless communication devices (WDEVs) 118-132 and BSs or APs 112-116 may include a processor and a communication interface to support communications with any other of the wireless communication devices 118-132 and BSs or APs 112-116. In an example of operation, a processor implemented within one of the devices (e.g., any one of the WDEVs 118-132 and BSs or APs 112-116) is configured to process at least one signal received from and/or to generate at least one signal to be transmitted to another one of the devices (e.g., any other one of the WDEVs 118-132 and BSs or APs 112-116).

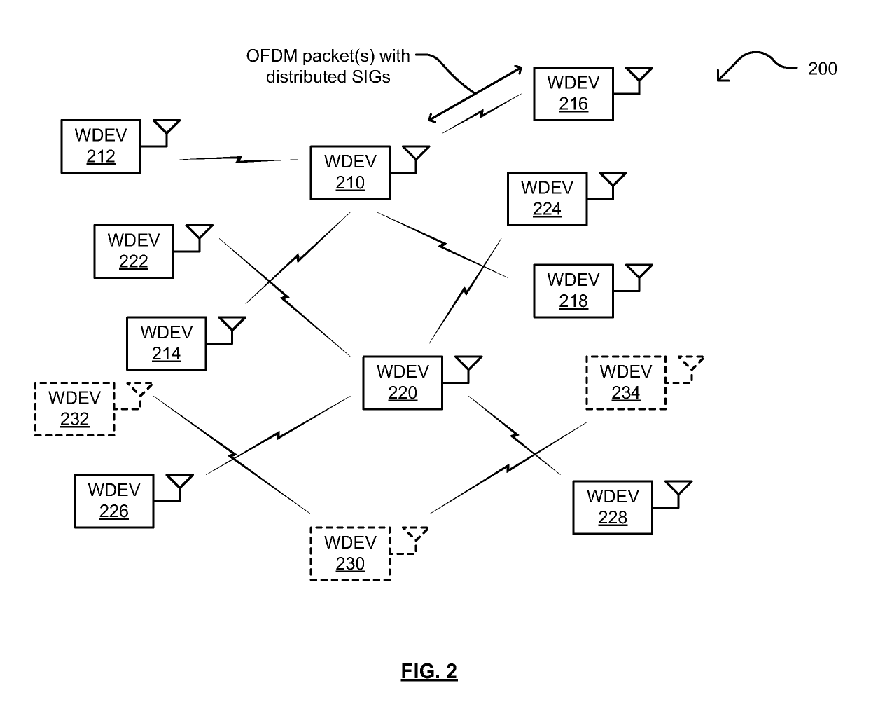

Note that general reference to a communication device, such as a wireless communication device (e.g., WDEVs) 118-132 and BSs or APs 112-116 in FIG. 1, or any other communication devices and/or wireless communication devices may alternatively be made generally herein using the term ‘device’ (e.g., with respect to FIG. 2 below, “device 210” when referring to “wireless communication device 210” or “WDEV 210,” or “devices 210-234” when referring to “wireless communication devices 210-234”; or with respect to FIG. 3 below, use of “device 310” may alternatively be used when referring to “wireless communication device 310”, or “devices 390 and 391 (or 390-391)” when referring to wireless communication devices 390 and 391 or WDEVs 390 and 391).

The processor of any one of the various devices, WDEVs 118-132 and BSs or APs 112-116, may be configured to support communications via at least one communication interface with any other of the various devices, WDEVs 118-132 and BSs or APs 112-116. Such communications may be uni-directional or bi-directional between devices. Also, such communications may be uni-directional between devices at one time and bi-directional between those devices at another time.

In an example implementation, one of the devices, such as device 130, includes a communication interface and a processor that cooperatively operate to support communications with another device, such as device 116, among others within the system. The processor is operative to generate and interpret different signals, frames, packets, symbols, etc. for transmission to other devices and that have been received from other devices. Considering one particular type of transmission between devices, the device 130 generates an orthogonal frequency division multiplexing (OFDM) packet that includes one or more OFDM symbols. The device 130 generates a preamble of the OFDM packet that includes signal fields (SIGs) (e.g., more than one in a distributed implementation) that specify first characteristics of a remainder of the OFDM packet (e.g., data, payload, etc.) that follows the SIG fields. A first at least one SIG includes information to specify second characteristics of a second at least one SIG that follows the first at least one SIG. After generation of the OFDM packet, the device 130 transmits the OFDM packet to another wireless communication device (e.g., device 116). Note also that device 130 includes capability to receive, demodulate, process, and interpret such OFDM packets transmitted by other devices of the system (e.g., 116).

The second characteristics specified by the first at least one SIG can include any one or more of a size of a guard interval (GI) between the first at least one SIG and the second at least one SIG, whether or not such a guard interval is included between the first at least one SIG and the second at least one SIG, a location of such a guard interval if included, a modulation coding set (MCS) of the second at least one SIG, a length of the second at least one SIG, a number of OFDM symbols within the second at least one SIG, among other possible characteristics. In one particular implementation, the first at least one SIG includes two SIGs (e.g., SIG1 and SIG2 as shown in some examples), and the second at least one SIG includes one SIG (e.g., SIG3 as shown in some examples). Note also that the first at least one SIG and the second at least one SIG may have and be generated by any of a number of different characteristics. Generally, the first at least one SIG specifies characteristics of the second at least one SIG, and the first and second at least one SIGs cooperatively specify characteristics of the remainder of the OFDM packet. Note that the second at least one SIG can have a variable length that is specified by the first at least one SIG. This provides a great deal of flexibility to specify any desired characteristics of the remainder of the OFDM packet. Note also that the first at least one SIG may include one SIG that is a copy of another SIG therein. The copy may be a cyclically shifted copy in some examples.

FIG. 2 is a diagram illustrating an embodiment 200 of dense deployment of wireless communication devices (shown as WDEVs in the diagram). Any of the various WDEVs 210-234 may be access points (APs) or wireless stations (STAs). For example, WDEV 210 may be an AP or an AP-operative STA that communicates with WDEVs 212, 214, 216, and 218 that are STAs. WDEV 220 may be an AP or an AP-operative STA that communicates with WDEVs 222, 224, 226, and 228 that are STAs. In certain instances, at least one additional AP or AP-operative STA may be deployed, such as WDEV 230 that communicates with WDEVs 232 and 234 that are STAs. The STAs may be any type of one or more wireless communication device types including wireless communication devices 118-132, and the APs or AP-operative STAs may be any type of one or more wireless communication devices including as BSs or APs 112-116. Different groups of the WDEVs 210-234 may be partitioned into different basic services sets (BSSs). In some instances, at least one of the WDEVs 210-234 are included within at least one overlapping basic services set (OBSS) that cover two or more BSSs. As described above with the association of WDEVs in an AP-STA relationship, one of the WDEVs may be operative as an AP and certain of the WDEVs can be implemented within the same basic services set (BSS).

This disclosure presents novel architectures, methods, approaches, etc. that allow for improved spatial re-use for next generation WiFi or wireless local area network (WLAN) systems. Next generation WiFi systems are expected to improve performance in dense deployments where many clients and AP are packed in a given area (e.g., which may be an area [indoor and/or outdoor] with a high density of devices, such as a train station, airport, stadium, building, shopping mall, arenas, convention centers, colleges, downtown city centers, etc. to name just some examples). Large numbers of devices operating within a given area can be problematic if not impossible using prior technologies.

In an example of operation, devices 210 and 216 communicate with one another. The device 210 includes a communication interface and a processor that cooperatively operate to support communications with another device, such as device 216, among others within the system. The processor is operative to generate and interpret different signals, frames, packets, symbols, etc. for transmission to other devices and that have been received from other devices. Considering one particular type of transmission between devices, the device 210 generates an OFDM packet that includes one or more OFDM symbols. The device 210 generates a preamble of the OFDM packet that includes signal fields (SIGs) (e.g., more than one in a distributed implementation) that specify first characteristics of a remainder of the OFDM packet (e.g., data, payload, etc.) that follows the SIG fields. A first at least one SIG includes information to specify second characteristics of a second at least one SIG that follows the first at least one SIG. After generation of the OFDM packet, the device 210 transmits the OFDM packet to another wireless communication device (e.g., device 216). Note also that device 210 includes capability to receive, demodulate, process, and interpret such OFDM packets transmitted by other devices of the system (e.g., 216). This embodiment 200 shows an example where devices within a very dense implementation of devices can adaptively generate preambles for OFDM packets based on varying conditions. For example, as traffic or interference within the communication system changes, a device can generate a preamble for a particular type of OFDM packet that is suitable for transmission to another device in the system based on the changing operating conditions.

FIG. 3A is a diagram illustrating an example 301 of communication between wireless communication devices. A wireless communication device 310 (e.g., which may be any one of devices 118-132 as with reference to FIG. 1) is in communication with another wireless communication device 390 via a transmission medium. The wireless communication device 310 includes a communication interface 320 to perform transmitting and receiving of at least one packet or frame (e.g., using a transmitter 322 and a receiver 324) (note that general reference to packet or frame may be used interchangeably). The wireless communication device 310 also includes a processor 330, and an associated memory 340, to execute various operations including interpreting at least one packet or frame transmitted to wireless communication device 390 and/or received from the wireless communication device 390 and/or wireless communication device 391. The wireless communication devices 310 and 390 (and/or 391) may be implemented using at least one integrated circuit in accordance with any desired configuration or combination of components, modules, etc. within at least one integrated circuit. Also, the wireless communication devices 310, 390, and 391 may each include more than one antenna for transmitting and receiving of at least one packet or frame (e.g., WDEV 390 may include m antennae, and WDEV 391 may include n antennae).

FIG. 3B is a diagram illustrating another example 302 of communication between wireless communication devices. The communication interface 320 of WDEV 310 is configured to receive a first signal (e.g., one or more OFDM packets with distributed SIGs as described herein) from another wireless communication device (e.g., WDEV 390) and to transmit a second signal (e.g., one or more other OFDM packets with distributed SIGs as described herein) from the other wireless communication device (e.g., WDEV 390).

In an example of operation, devices 310 and 390 communicate with one another. The processor 330 of device 310 is operative to generate and interpret different signals, frames, packets, symbols, etc. for transmission to other devices and that have been received from other devices. For example, processor 330 generates an OFDM packet that includes one or more OFDM symbols. The processor 330 generates a preamble of the OFDM packet that includes signal fields (SIGs) (e.g., more than one in a distributed implementation) that specify first characteristics of a remainder of the OFDM packet (e.g., data, payload, etc.) that follows the SIG fields. A first at least one SIG includes information to specify second characteristics of a second at least one SIG that follows the first at least one SIG. After generation of the OFDM packet, the processor 330 transmits the OFDM packet to another wireless communication device (e.g., device 390) via communication interface 320. Note also that processor 330 includes capability to receive, demodulate, process, and interpret such OFDM packets transmitted by other devices of the system (e.g., 390). This embodiment 200 shows an example where devices within a very dense implementation of devices can adaptively generate preambles for OFDM packets based on varying conditions. For example, as traffic or interference within the communication system changes, a device can generate a preamble for a particular type of OFDM packet that is suitable for transmission to another device in the system based on the changing operating conditions.

In another example of operation, the processor 330 of device 310 receives, via communication interface 320, another OFDM packet from device 390. The processor 330 processes a preamble of this other OFDM packet that signal fields (SIGs) that specify first characteristics of a remainder of this other OFDM packet that follows the SIG fields. The processor 330 then processed a first at least one SIG to determine second characteristics of a second at least one SIG that follows the first at least one SIG. The processor 330 then processes the second at least one SIG using the second characteristics to determine at least one characteristic of the first characteristics. Then, the processor 330 processed the remainder of this other OFDM packet that follows the plurality of SIG fields using the first characteristics. From another perspective, the processor 330 processes the first at least one SIG to determine the second characteristics of the second at least one SIG. The processor 330 then can determine the first characteristics of the remainder of this other OFDM packet based on information within one or both of the first at least one SIG and the second least one SIG.

FIG. 3C is a diagram illustrating another example 303 of communication between wireless communication devices. This diagram shows one possible construction of an OFDM packet. The OFDM packet includes a first at least one SIG followed by a second at least one SIG that is followed by the OFDM packet remainder (e.g., data, payload, etc.). Such SIGs can include various information to describe the OFDM packet including certain attributes as data rate, packet length, number of symbols within the packet, channel width, modulation encoding, modulation coding set (MCS), modulation type, whether the packet as a single or multiuser frame, frame length, etc. among other possible information. This disclosure presents a means by which a variable length second at least one SIG can be used to include any desired amount of information. By using at least one SIG that is a variable length, different amounts of information may be specified therein to adapt for any situation.

Note that the first at least one SIG can include a SIG and a copy of that SIG (or a cyclic shifted copy of that SIG) the second at least one SIG can include as few as one SIG. The first at least one SIG specifies one or more characteristics of the second at least one SIG. Information included within one or both of the first and second at least one SIGs specifies one or more other characteristics of the OFDM packet remainder. Some information regarding orthogonal frequency division multiplexing (OFDM) and/or orthogonal frequency division multiple access (OFDMA) is provided below.

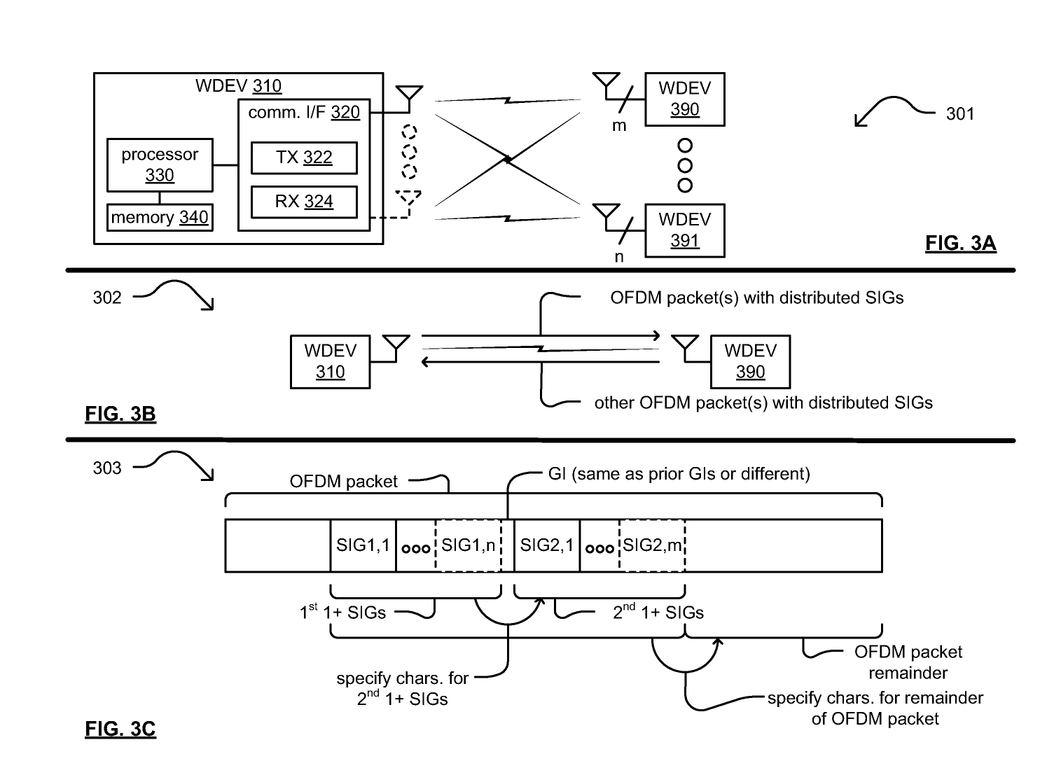

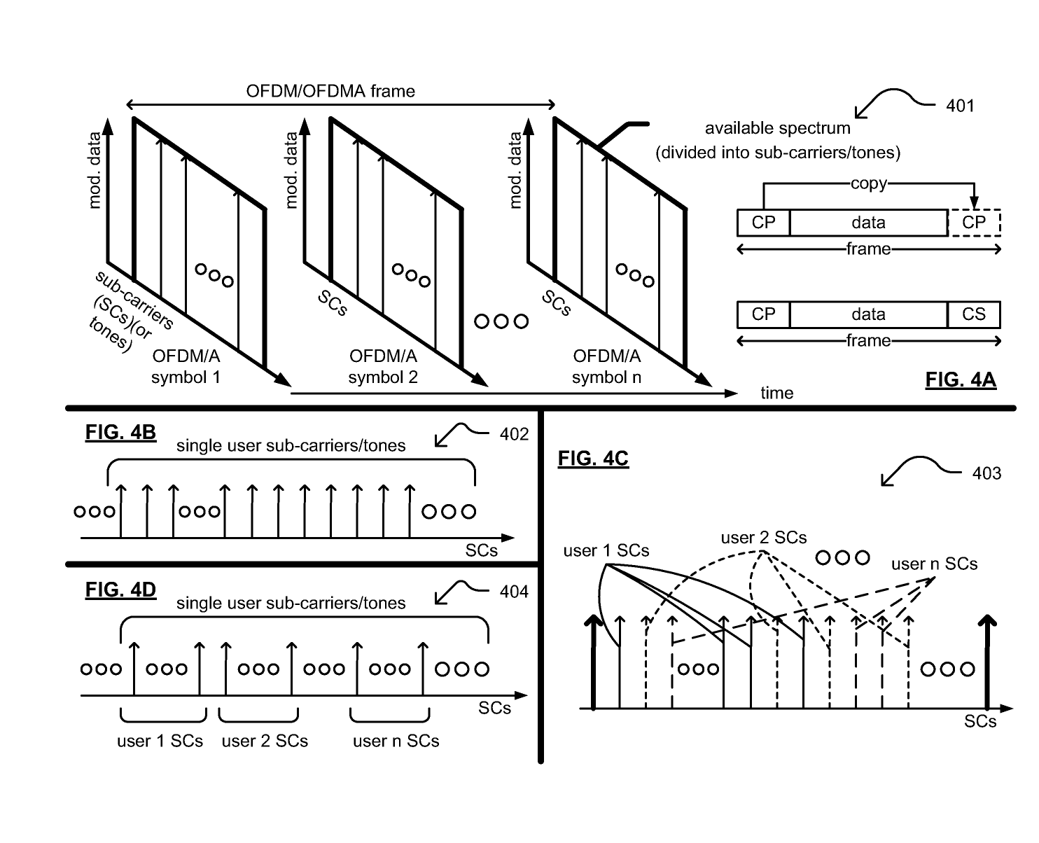

FIG. 4A is a diagram illustrating an example 401 of orthogonal frequency division multiplexing (OFDM) and/or orthogonal frequency division multiple access (OFDMA). OFDM's modulation may be viewed as dividing up an available spectrum into a plurality of narrowband sub-carriers (e.g., relatively lower data rate carriers). The sub-carriers are included within an available frequency spectrum portion or band. This available frequency spectrum is divided into the sub-carriers or tones used for the OFDM or OFDMA symbols and packets/frames. Typically, the frequency responses of these sub-carriers are non-overlapping and orthogonal. Each sub-carrier may be modulated using any of a variety of modulation coding techniques (e.g., as shown by the vertical axis of modulated data).

A communication device may be configured to perform encoding of one or more bits to generate one or more coded bits used to generate the modulation data (or generally, data). For example, a processor of a communication device may be configured to perform forward error correction (FEC) and/or error correction code (ECC) of one or more bits to generate one or more coded bits. Examples of FEC and/or ECC may include turbo code, convolutional code, turbo trellis coded modulation (TTCM), low density parity check (LDPC) code, Reed-Solomon (RS) code, BCH (Bose and Ray-Chaudhuri, and Hocquenghem) code, etc. The one or more coded bits may then undergo modulation or symbol mapping to generate modulation symbols. The modulation symbols may include data intended for one or more recipient devices. Note that such modulation symbols may be generated using any of various types of modulation coding techniques. Examples of such modulation coding techniques may include binary phase shift keying (BPSK), quadrature phase shift keying (QPSK), 8-phase shift keying (PSK), 16 quadrature amplitude modulation (QAM), 32 amplitude and phase shift keying (APSK), etc., uncoded modulation, and/or any other desired types of modulation including higher ordered modulations that may include even greater number of constellation points (e.g., 1024 QAM, etc.).

FIG. 4B is a diagram illustrating another example 402 of OFDM and/or OFDMA. A transmitting device transmits modulation symbols via the sub-carriers. OFDM and/or OFDMA modulation may operate by performing simultaneous transmission of a large number of narrowband carriers (or multi-tones). In some applications, a guard interval (GI) or guard space is sometimes employed between the various OFDM symbols to try to minimize the effects of ISI (Inter-Symbol Interference) that may be caused by the effects of multi-path within the communication system, which can be particularly of concern in wireless communication systems. In addition, a CP (Cyclic Prefix) and/or cyclic suffix (CS) (shown in right hand side of FIG. 4A) that may be a copy of the CP may also be employed within the guard interval to allow switching time, such as when jumping to a new communication channel or sub-channel, and to help maintain orthogonality of the OFDM and/or OFDMA symbols. Generally speaking, an OFDM and/or OFDMA system design is based on the expected delay spread within the communication system (e.g., the expected delay spread of the communication channel).

In a single-user system in which one or more OFDM symbols or OFDM packets/frames are transmitted between a transmitter device and a receiver device, all of the sub-carriers or tones are dedicated for use in transmitting modulated data between the transmitter and receiver devices. In a multiple user system in which one or more OFDM symbols or OFDM packets/frames are transmitted between a transmitter device and multiple recipient or receiver devices, the various sub-carriers or tones may be mapped to different respective receiver devices as described below with respect to FIG. 4C.

FIG. 4C is a diagram illustrating another example 403 of OFDM and/or OFDMA. Comparing OFDMA to OFDM, OFDMA is a multi-user version of the popular orthogonal frequency division multiplexing (OFDM) digital modulation scheme. Multiple access is achieved in OFDMA by assigning subsets of subcarriers to individual recipient devices or users. For example, first sub-carrier(s)/tone(s) may be assigned to a user 1, second sub-carrier(s)/tone(s) may be assigned to a user 2, and so on up to any desired number of users. In addition, such sub-carrier/tone assignment may be dynamic among different respective transmissions (e.g., a first assignment for a first packet/frame, a second assignment for second packet/frame, etc.). An OFDM packet/frame may include more than one OFDM symbol. Similarly, an OFDMA packet/frame may include more than one OFDMA symbol. In addition, such sub-carrier/tone assignment may be dynamic among different respective symbols within a given packet/frame or superframe (e.g., a first assignment for a first OFDMA symbol within a packet/frame, a second assignment for a second OFDMA symbol within the packet/frame, etc.). Generally speaking, an OFDMA symbol is a particular type of OFDM symbol, and general reference to OFDM symbol herein includes both OFDM and OFDMA symbols (and general reference to OFDM packet/frame herein includes both OFDM and OFDMA packets/frames, and vice versa). FIG. 4C shows example 403 where the assignments of sub-carriers to different users are intermingled among one another (e.g., sub-carriers assigned to a first user includes non-adjacent sub-carriers and at least one sub-carrier assigned to a second user is located in between two sub-carriers assigned to the first user). The different groups of sub-carriers associated with each user may be viewed as being respective channels of a plurality of channels that compose all of the available sub-carriers for OFDM signaling.

FIG. 4D is a diagram illustrating another example 404 of OFDM and/or OFDMA. This example 404 where the assignments of sub-carriers to different users are located in different groups of adjacent sub-carriers (e.g., first sub-carriers assigned to a first user include first adjacently located sub-carrier group, second sub-carriers assigned to a second user include second adjacently located sub-carrier group, etc.). The different groups of adjacently located sub-carriers associated with each user may be viewed as being respective channels of a plurality of channels that compose all of the available sub-carriers for OFDM signaling.

Generally, a communication device may be configured to include a processor configured to process received OFDM or OFDMA symbols and/or frames and to generate such OFDM or OFDMA symbols and/or frames. Note that general reference to OFDM herein, such as with respect to an OFDM packet, may be adapted to include OFDM or OFDMA. The processor of any communication device described herein may be implemented to generate an OFDM packet based on any of the examples, embodiments, or variants described herein. That communication device may then be implemented to transmit such an OFDM packet to another communication device.

In prior IEEE 802.11 legacy prior standards, protocols, and/or recommended practices, including those that operate in the 2.4 GHz and 5 GHz frequency bands, certain preambles are used. For use in the development of a new standard, protocol, and/or recommended practice, a new preamble design is presented herein that permits classification of all current preamble formats while still enabling the classification of a new format by new devices.

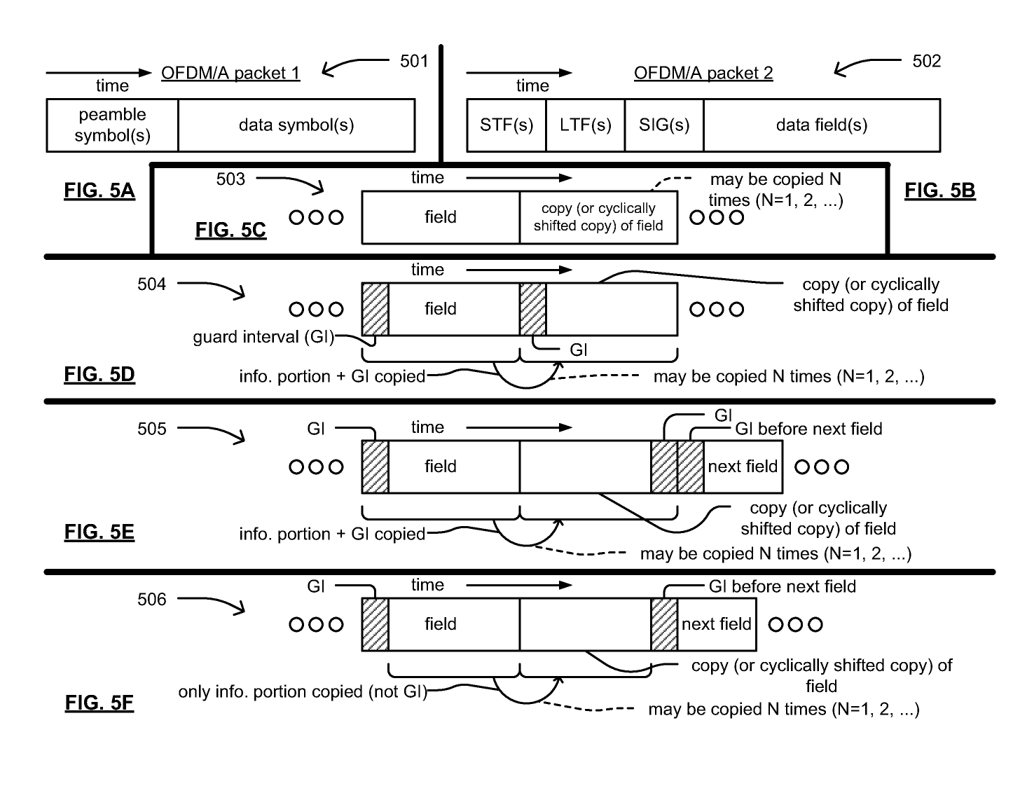

FIG. 5A is a diagram illustrating an example 501 of an OFDM/A packet. This packet includes at least one preamble symbol followed by at least one data symbol. The at least one preamble symbol includes information for use in identifying, classifying, and/or categorizing the packet for appropriate processing.

FIG. 5B is a diagram illustrating another example 502 of an OFDM/A packet of a second type. This packet also includes a preamble and data. The preamble is composed of and/or short training field (STF), at least one long training field (LTF), and at least one signal field (SIG). The data is composed of at least one data field. In both this example 502 and the prior example 501, the at least one data symbol and/or the at least one data field may generally be referred to as the payload of the packet. Among other purposes, STFs and LTFs can be used to assist a device to identify that a frame is about to start, to synchronize timers, to select an antenna configuration, to set receiver gain, to set up certain the modulation parameters for the remainder of the packet, to perform channel estimation for uses such as beamforming, etc. Among other purposes, the SIGs can include various information to describe the OFDM packet including certain attributes as data rate, packet length, number of symbols within the packet, channel width, modulation encoding, modulation coding set (MCS), modulation type, whether the packet as a single or multiuser frame, frame length, etc. among other possible information. This disclosure presents a means by which a variable length second at least one SIG can be used to include any desired amount of information. By using at least one SIG that is a variable length, different amounts of information may be specified therein to adapt for any situation.

Various examples are described below for possible designs of a preamble for use in wireless communications as described herein.

FIG. 5C is a diagram illustrating another example 503 of at least one portion of an OFDM/A packet of another type. A field within the packet may be copied one or more times therein (e.g., where N is the number of times that the field is copied, and N is any positive integer greater than or equal to one). This copy may be a cyclically shifted copy. The copy may be modified in other ways from the original from which the copy is made.

FIG. 5D is a diagram illustrating another example 504 of at least one portion of an OFDM/A packet of another type. In this diagram, a guard interval (GI) precedes the field and both the GI and the field are copied. In this diagram as well, copy may be a cyclically shifted copy. Note that other examples may copy only the information within the field but not the GI that precedes the field.

FIG. 5E is a diagram illustrating another example 505 of at least one portion of an OFDM/A packet of another type. In this diagram, a GI also precedes the field and both the GI and the field are copied, but the GI is placed instead at the end of the information within the copied portion. The order of the GI and information portion that are copied is modified within the copy. In an instance in which a next field within the packet is also preceded by a GI, then 2 consecutive GIs will occur as shown in the diagram.

FIG. 5F is a diagram illustrating another example 506 of at least one portion of an OFDM/A packet of another type. In this diagram, a GI also precedes the field but only the field is copied. A GI may be included before a next field within the packet. In this diagram, only one GI will be included between the copy of the field and the next field.

Note that other examples of time repetition coding in which one or more fields of a packet are repeated or copied one or more times may be performed. For example, if desired, two consecutive fields may be copied in such a time repetition coding implementation. Various permutations of placement of GIs and other placement within the copies may be performed based on the principles described in these examples. For example, the order of various fields within copies may be different. Certain copies of the fields may undergo cyclic shifting in the copy process (e.g., such that the copy is a cyclically shifted copy). Also, note that partial copying of information within a field may be performed. For example, a modified copy may include a portion or all of the information within another field. There may be instances in which a field can include a repetition or copy of information within the prior field as well as additional or new information. For example, in certain of the SIG related examples, a first at least one SIG can include information within a prior of legacy SIG (e.g., L-SIG) therein. The use of time repetition coding as presented in this disclosure allows for robustness and can improve a receiver's ability to interpret received signals, packets, symbols, frames, etc. properly.

This disclosure presents a novel way to generate a preamble to assist a receiver wireless communication device (e.g., wireless station (STA)) to perform proper classification and processing of a received packet (e.g., an OFDM packet). For example, the length of a guard interval (GI) between the first at least one SIG and the second at least one SIG may be different in different examples (e.g., a short (0.8 μs) or long (3.2 μs) guard interval (GI)). The receiver device can determine the length of this GI before reaching the second at least one SIG in the packet. In some examples described herein that include first at least one SIG that includes two SIGs (SIG1/2) and the second at least one SIG (e.g., SIG3), the receiver device can determine the length of this GI before reaching SIG3 and will know before reaching the SIG3 field what type of GI was used in a communication. In such an example, the two SIGs (SIG1/2) may be viewed as a first portion of this overall SIG that has a first structure, and SIG3 may be viewed as a second portion of this overall SIG that has a second structure.

Several options may be employed including any one or more of: SIG1/2 fields have a separate encoder than SIG3 (e.g., first information is used in a first encoding process to generate SIG1/2 and second information is used in a second encoding process to generate SIG3), pilots on SIG1 and SIG2 used to convey one bit of information.

Generally speaking, such forms of termination are used to return the state of the encoder to a predetermined, known, or determinable state. Note also that if SIG1/2 fields have a separate encoder than SIG3, any one of several options can be used with any one or more of: standard terminated binary convolutional code (BCC) (e.g., in which the state of encoder begins and returns to the same state, such as state 0, at the beginning and end of every encoding process such as over a certain number of symbols, frames, etc.), transmission of a subset of termination bits (e.g., 3 of normal 6 tail bits) to assist in the returning of the state to a known value, terminated BCC with up to 12 bits punctured throughout the codeword (puncturing pattern specific to the short codeword, as opposed to the standard puncturing pattern used in the 802.11 spec), tail-biting BCC (e.g., in which the state at the end of an encoding process is the same as whatever it was at the beginning of that encoding process, but it need not necessarily be a predetermined state, such as state 0), etc. Generally speaking, in this example, separate information is used to generate SIG1/2 and SIG3 (e.g., a first one or more codewords are used to generate SIG1/2, and a second one or more codewords are used to generate SIG3). At such, when receiving and interpreting such an OFDMA packet, SIG1/2 and SIG3 will consequently be decoded to generate estimates of the first one or more codewords and second one or more codewords, respectively.

Note also that the SIG1/2 can include pilot or other information modulated on extra sub-carriers or tones to enable SIG3 to use those additional tones for data modulation. For example, consider that sub-carriers outside of a centrally located contiguous set of sub-carriers (e.g., outside of −26 to 26) are unused in SIG1/2 for SIG related information, then pilot or other information may be modulated on those unused sub-carriers. Then, SIG3 can use those unused sub-carriers that carry the pilot or other information in SIG1/2 (e.g., can use sub-carriers 27 up to 31 and −27 to −31). Note also that the SIG1/2 can also signal a different modulation or modulation coding set (MCS) for use in SIG3, the length of SIG3, a number of symbols in SIG3, the size of a GI, if any, between SIG1/2 and SIG3, etc. In some examples, one or both of SIG1/2 or SIG3 may also repeat or partially repeat information carried by a legacy or prior SIG within the packet (e.g., the L-SIG, and can signal the length). This may be desirable within certain applications and implementations. For example, within certain implementations that may be more susceptible to noise, interference, etc. (e.g., outdoor scenarios), the SIG1/2 may use a bit therein set to a particular value to distinguish between different environments (e.g., indoor and outdoor). The L-SIG information is repeated in some implementations but not in others (e.g., the value of that bit determines the interpretation of the other bits (fields) in the SIG1/2/3). Note also that SIG1/2 may also add extra parity bits to improve the reliability of the legacy or prior SIG within the packet (e.g., L-SIG field).

Also, other methods to signal GI that allow single encoder across SIG 1/2/3 fields may be used with a short GI bit signaled using a fixed set of subcarriers in SIG1/2. These subcarriers are used to convey a single bit, and that single bit is repetition coded over this set of subcarriers (peak to average power ratio (PAPR) lowering sequence can be applied on top of this repetition on said subcarriers). These subcarriers are not used by the BCC codeword spanning SIG 1/2/3. Set of subcarriers can include pilot tones. Alternatively, a signal short GI bit may be generated by repetition coding on the imaginary components of the even tones used in SIG 1/2. Imaginary component weakly loaded compared to real component (on all tones) so that rotated BPSK detection is not significantly affected. Alternatively, a communication device can also use the real component transmitted on pilot tones.

An extended range preamble or lower rate preamble may be employed in some situations. It may be desirable in some implementations also to have an extended range preamble that is designed to work at the lower operating signal to interference noise ratio (SINR) or signal to noise ratio (SNR) than is required for effective coding rates (e.g., less than MCSO) and/or narrower bandwidths.

In addition to any of the SIG field preamble types already described, it may be desirable also to have a lower rate preamble that is designed to work at lower operating signal to interference noise ratio (SINR) than what's achievable with MCSO rate (e.g., that is the lowest rate currently used for the previous preamble designs). Such low operating SINR can be used for extended range or for high overlapping basic services set (OBSS) interference cases. The lower data rates expected are MCSO with repetition 4 and repetition 2.

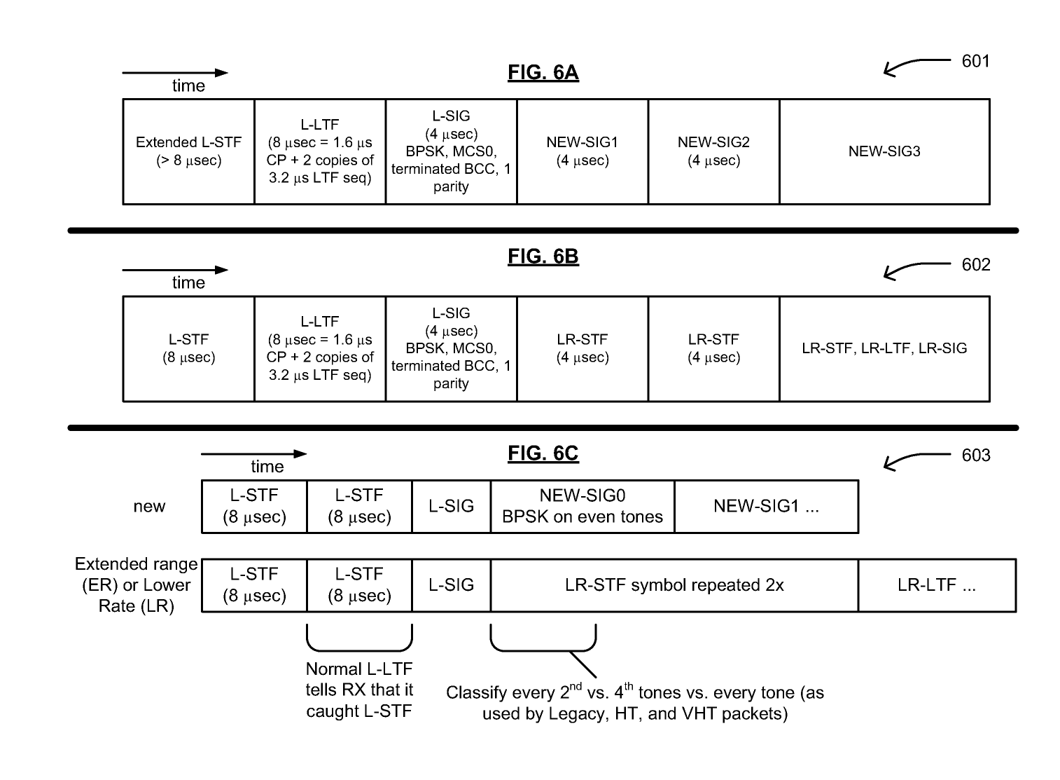

FIG. 6A is a diagram illustrating an example 601 of a preamble of an OFDM/A packet tailored for extended range and/or lower rate applications. In this example 601, the L-STF field is increased in length (e.g., further repetition of 0.8 μs sequence that L-STF is composed of) to allow acquisition to work at lower SNR's. Also, the NEW-SIG1/2 contents are changed to one of the following:

1. BPSK on even tones with a specified PN sequence. This may be used to allow for maximal differentiation from non-extended range HEW preamble (e.g., design 1) PN sequence can be chosen such that it does not match any valid design 1 codeword).

2. Combination of data and specified PN sequence on even tones.

3. Combination of data and specified PN sequence on every 4^{th} tone.

4. Time and/or frequency repetition on data, to allow lower SNR decoding.

The NEW-SIG3 is changed as follows: (1) increased time/frequency repetition and (2) different FFT size and/or GI length. Note that additional LTF's may be inserted, before and/or after NEW-SIG3.

FIG. 6B is a diagram illustrating another example 602 of a preamble of an OFDM/A packet tailored for extended range and/or lower rate applications. In this example 602, a NEW-SIG1/2 field from concept/design 1 is replaced by a low rate/long range (LR)-STF field (e.g., a new field) with contents changed to a specific PN sequence on every 4^{th} tone. The PN sequence may be the same as the L-STF or different with specific design for low PAPR that allows boosting for improved acquisition.

The location of the tones could be similar to the L-STF or shifted by 2 tones (tones=2 mod(4)) to allow classification relative to the L-STF. Alternatively, classification could be performed after this NEW-STF field by using a specifically designed NEW-LTF field with a sequence orthogonal to the L-LTF sequence. A receiver will need to do 3-way classification—the nested property of the design can be utilized in constructing appropriate metrics for classification:

1. The low rate preamble uses only every 4^{th} tone and also repeats the same information on 2 or more symbols

2. The NEW preamble as a design above that uses only even tones with different information on the 2 symbols

3. Legacy preambles use all tones with different information on the 2 symbols

4. The receiver can average the 2 symbols and then proceed to compare energy on the respective groups of tones to derive the correct preamble option. See next 2 slides for further discussion.

The LR-SIG field is preceded by the following fields:

1. Possibly extra LR-STF symbols for improved acquisition

2. Possibly more than 2 LR-LTF to improve channel estimation at very low SNR

The LR-SIG field uses longer symbols (4×) for robust operation in longer delay spread and lower coding rate in-line with the lowest coding rate supported in the packet.

If desired, the LR-STF is boosted (e.g., amplified, scaled upwards, etc.) to assist in the acquisition of the low rate preamble and the required low rate signal to interference noise ratio (SINR). For example, this may be used when a low PAPR is desired for such transmissions. A search across possible STF sequences that provide low PAPR provides at least the following options. In this search, it is assumed that the tones modulated are the same tones as in the L-STF (e.g., 12 tones on 0 mod(4) locations excluding the DC).

Several options of short training field (STF) sequences (e.g., shown as “stf_seq”) that may be used to provide for a relatively lower PAPR are presented below:

LR-STF Sequences

PAPR=1.2 dB, stf_seq=[−1 1 2 −2 −1 2 2 −2 −1 −2 −1 −1]

PAPR=1.2 dB, stf_seq=[−1 1 −2 1 −2 −2 −2 −1 2 2 −1 −1]

PAPR=1 dB, stf_seq=[1.0000 −1.4142 1.0000 2.0000 −2.0000 2.0000 2.0000 2.0000 2.0000 −1.0000 −1.4142 −1.0000]

PAPR=1 dB, stf_seq=[1.0000 1.4142 1.0000 −2.0000 −2.0000 −2.0000 −2.0000 2.0000 −2.0000 −1.0000 1.4142 −1.0000]

PAPR=1 dB, stf_seq=[−1.0000 −1.4142 −1.0000 2.0000 2.0000 2.0000 2.0000 −2.0000 2.0000 1.0000 −1.4142 1.0000]

PAPR=1 dB, stf_seq=[−1.0000 1.4142 −1.0000 −2.0000 2.0000 −2.0000 −2.0000 −2.0000 −2.0000 1.0000 1.4142 1.0000]

FIG. 6C is a diagram illustrating another example 603 of a preamble of an OFDM/A packet tailored for extended range and/or lower rate applications. If a receiver communication device (RX) acquires L-STF of Low Rate preamble, then classification can be made as shown using the normal L-LTF that tells the device that it received and successfully processes the L-STF. Note that this may not be the case for very low SINR conditions where low rate packets are expected to work.

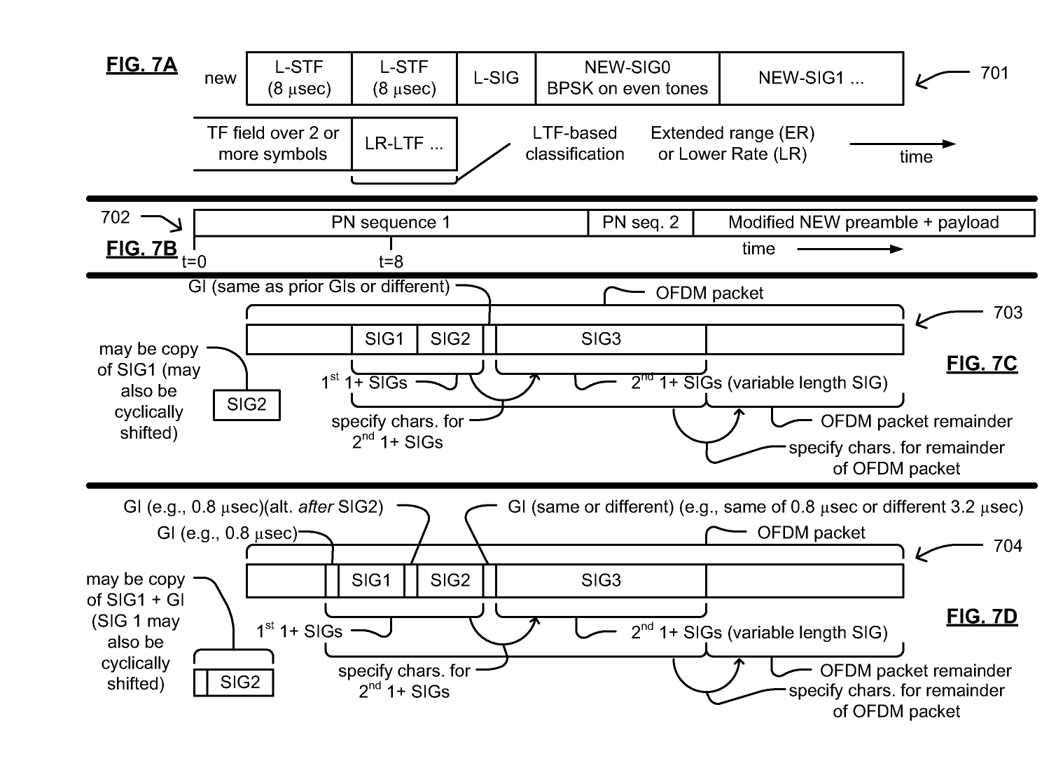

FIG. 7A is a diagram illustrating another example 701 of a preamble of an OFDM/A packet tailored for extended range and/or lower rate applications. If a RX did not successfully acquire L-STF of Low Rate preamble (this may be the typical case for very low SINR conditions where low rate packets are expected to work), then in this case, the RX of a device that is configured to try to lock on a low rate preamble needs to know that it did not lock onto the L-STF but rather on the LR-STF. This is enabled by a design as described with reference to FIG. 7B such that the location of LR-STF tones is different from L-STF tones and/or a specific LR-LTF sequence which is orthogonal to L-LTF.

FIG. 7B is a diagram illustrating another example 702 of a preamble of an OFDM/A packet tailored for extended range and/or lower rate applications. This example 702 prepends one of the normal range NEW preambles (with some modification) with a long, known pseudo-noise (PN) sequence. This can allow a device to be configured to acquire frame at very low SNR via the long PN sequence (seq1 and seq2). Also, the PN seq1 is followed by short PN seq2 so that RX can identify the end of the PN portion.

Compatibility with legacy prior standards, protocols, and/or recommended practices is maintained via the inclusion of the normal NEW format. Non-HEW devices (e.g., those not compatible with prior standards, protocols, and/or recommended practices) will not be aware of the long PN sequence, but they will properly decode the L-STF/L-LTF/L-SIG.

This modified NEW preamble is similar, but not identical, to one of the previously proposed NEW preamble designs. This modified NEW preamble begins with L-STF/L-LTF/L-SIG. The code rate of all fields modified (e.g., add time/frequency rep of 2× or greater) so that it can be decoded at low SNR. A device may be configured to know that a frame that begins with PN sequences 1 and 2 are of the extended frame type, and thus are aware of these modifications to the NEW portion of the preamble.

Note also that a new preamble may need to support allowing the device to be configured to perform carrier frequency offset (CFO) estimation with greater accuracy than is possible with current preamble. This can be enabled by adding additional LTF field(s) after the initial SIG field. Also, additional LTF field(s) may always be present, or may be optionally present and signaled with a bit in the SIG field.

FIG. 7C is a diagram illustrating another example 703 of at least one portion of an OFDM/A packet of another type. In this diagram, the first at least one SIG includes SIG1 and SIG2, and the second at least one SIG includes SIG3. SIG2 may be a copy of SIG1 or a cyclic shifted copy of SIG1. A GI precedes the second at least one SIG that includes SIG3, and the length or duration of the GI is specified within one or both of SIG1/2. SIG3 may be of any particular length, and the length is specified within one or both of SIG1/2.

FIG. 7D is a diagram illustrating another example 704 of at least one portion of an OFDM/A packet of another type. In this diagram, the first at least one SIG includes SIG1 and SIG2, and the second at least one SIG includes SIG3. A GI precedes the SIG1, and another GI precedes the SIG2. Yet another GI precedes the SIG3. The GI that precedes the SIG3 may be the same or different than the GIs that precede SIG1 and SIG2. For example, the GIs that precede SIG1 and SIG2 may be short (0.8 μs) and the GI that precedes the SIG3 may also be short (0.8 μs). Alternatively, the GIs that precede SIG1 and SIG2 may be short (0.8 μs) and the GI that precedes the SIG3 may be long (3.2 μs).

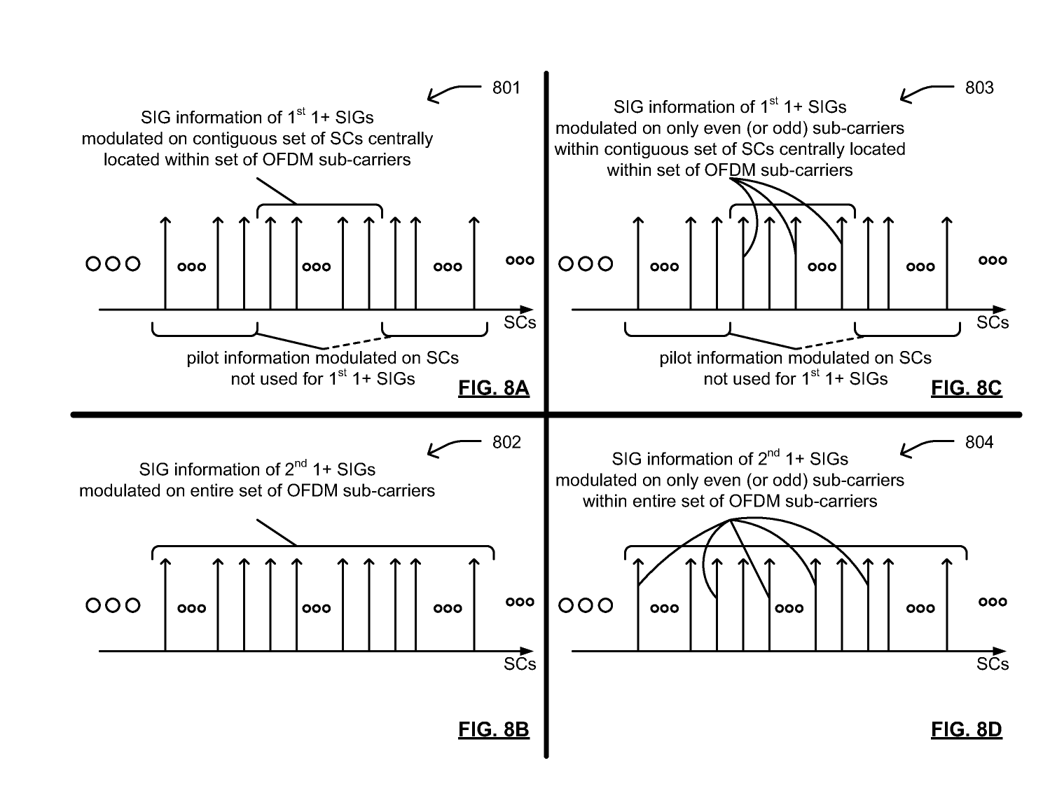

FIG. 8A is a diagram illustrating an example 801 of SIG information modulated on a contiguous set of sub-carriers (SCs) within a set of OFDM/A sub-carriers for a first at least one signal field (SIG) (e.g., first at least one SIG). In this diagram, SIG information of the first at least one SIG (e.g., SIG1/2) is modulated on a contiguous set of sub-carriers that is centrally located within a set of OFDM sub-carriers and pilot information (or other information) is modulated on at least one other contiguous subset set of sub-carriers that is adjacently located to the contiguous subset of sub-carriers within the set of OFDM sub-carriers. For example, consider that the centrally located contiguous set of sub-carriers includes those numbered [−N:N], and the set of OFDM sub-carriers includes those numbered [−M:M], where M and N are positive integers and M is greater than N, then SIG information of the first at least one SIG is modulated on the sub-carriers [−N:N] and pilot information (or other information) is modulated on sub-carriers [−M:−(N+1) and/or (N+1):M].

FIG. 8B is a diagram illustrating another example 802 of SIG information modulated on all sub-carriers of a contiguous set of SCs within a set of OFDM/A sub-carriers for at least one SIG (e.g., second at least one SIG). This diagram may be viewed in conjunction with FIG. 8A. In this diagram, SIG information of the second at least one SIG (e.g., SIG3) is modulated on the set of OFDM sub-carriers. For example, consider that the set of OFDM sub-carriers includes those numbered [−M:M], where M is a positive integer, then SIG information of the second at least one SIG is modulated on the sub-carriers [−M:M].

FIG. 8C is a diagram illustrating an example 803 of SIG information modulated on only even (or odd) sub-carriers (SCs) a contiguous set of sub-carriers (SCs) within a set of OFDM/A sub-carriers (e.g., first at least one SIG). In this diagram, SIG information of the first at least one SIG (e.g., SIG1/2) is modulated on only even sub-carriers of a contiguous set of sub-carriers that is centrally located within a set of OFDM sub-carriers and pilot information (or other information) is modulated on only even sub-carriers of at least one other contiguous subset set of sub-carriers that is adjacently located to the contiguous subset of sub-carriers within the set of OFDM sub-carriers. For example, consider that the centrally located contiguous set of sub-carriers includes those numbered [−N:N], and the set of OFDM sub-carriers includes those numbered [−M:M], where M and N are positive integers and M is greater than N, then SIG information of the first at least one SIG is modulated on only even sub-carriers of the sub-carriers [−N:N] and pilot information (or other information) is modulated on only even sub-carriers of sub-carriers [−M:−(N+1) and/or (N+1):M]. Note that an alternative implementation may include modulation on odd sub-carriers instead of even sub-carriers.

FIG. 8D is a diagram illustrating an example 804 of SIG information modulated on only even (or odd) sub-carriers (SCs) of all sub-carriers of a contiguous set of SCs within a set of OFDM/A sub-carriers for at least one SIG (e.g., second at least one SIG). This diagram may be viewed in conjunction with FIG. 8C. In this diagram, SIG information of the second at least one SIG (e.g., SIG3) is modulated on only even sub-carriers of the set of OFDM sub-carriers. For example, consider that the set of OFDM sub-carriers includes those numbered [−M:M], where M is a positive integer, then SIG information of the second at least one SIG is modulated on only even sub-carriers the sub-carriers [−M:M]. Note that an alternative implementation may include modulation on odd sub-carriers instead of even sub-carriers.

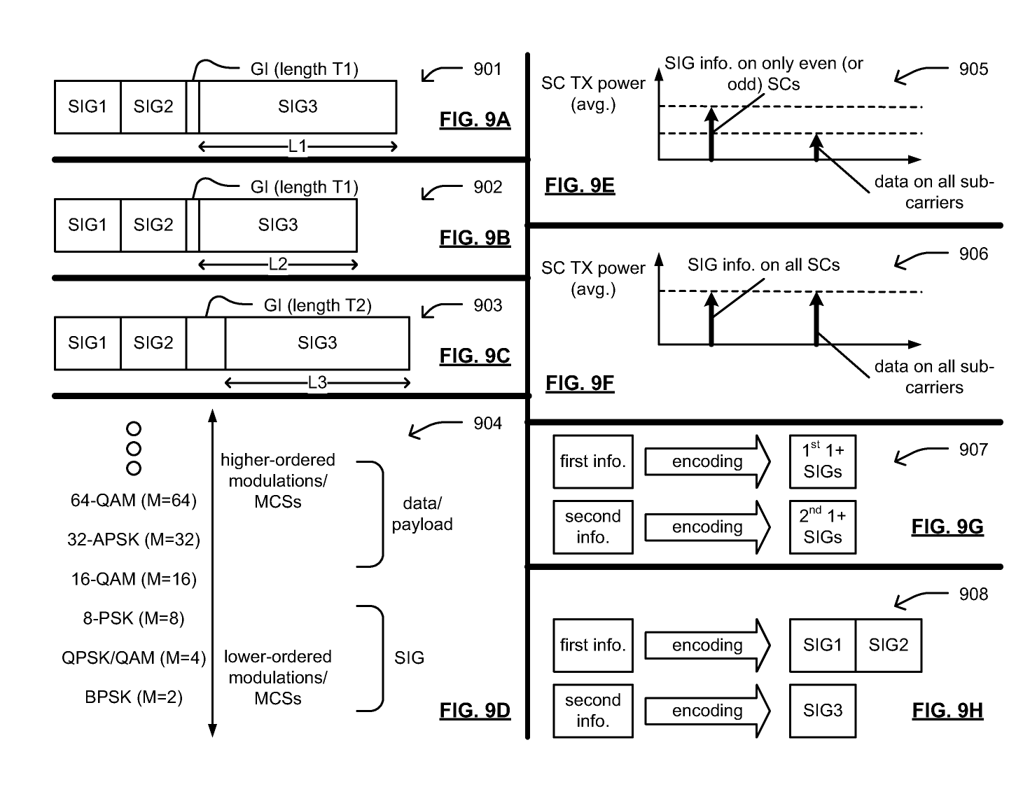

FIG. 9A is a diagram illustrating another example 901 of at least one portion of an OFDM/A packet of another type. In this diagram, the first at least one SIG includes two SIGs (SIG1 and SIG2) and the second at least one SIG includes one SIG (SIG3). The SIG2 may be a copy, a cyclic shifted copy, with or without copies of GIs, etc. of SIG 1. A GI of length T1 precedes SIG3, and SIG3 has length L1. The length of the GI and the length of SIG3 are specified within one or both of SIG1 and SIG2.

FIG. 9B is a diagram illustrating another example 902 of at least one portion of an OFDM/A packet of another type. In this diagram, the first at least one SIG includes two SIGs (SIG1 and SIG2) and the second at least one SIG includes one SIG (SIG3). The SIG2 may be a copy, a cyclic shifted copy, with or without copies of GIs, etc. of SIG 1. A GI of length T1 precedes SIG3, and SIG3 has length L2. The length of the GI and the length of SIG3 are specified within one or both of SIG1 and SIG2. Note that the length of SIG3 in this diagram is different than the length and the prior diagram.

FIG. 9C is a diagram illustrating another example 903 of at least one portion of an OFDM/A packet of another type. In this diagram, the first at least one SIG includes two SIGs (SIG1 and SIG2) and the second at least one SIG includes one SIG (SIG3). The SIG2 may be a copy, a cyclic shifted copy, with or without copies of GIs, etc. of SIG 1. A GI of length T2 precedes SIG3, and SIG3 has length L3. The length of the GI and the length of SIG3 are specified within one or both of SIG1 and SIG2. For example, consider that the GI that precedes SIG3 is FIGS. 9A and 9B is 0.8 μs, then the GI in FIG. 9C may be 3.2 μs. Generally, the length or duration of the GI between the first at least one SIG and the second at least one SIG is specified within the first at least one SIG.

FIG. 9D is a diagram illustrating an example 904 of different types of modulations or modulation coding sets (MCSs) used for modulation of information within different fields within an OFDM/A packet. Information, data, etc. may be modulated using various modulation coding techniques. Examples of such modulation coding techniques may include binary phase shift keying (BPSK), quadrature phase shift keying (QPSK) or quadrature amplitude modulation (QAM), 8-phase shift keying (PSK), 16 quadrature amplitude modulation (QAM), 32 amplitude and phase shift keying (APSK), 64-QAM, etc., uncoded modulation, and/or any other desired types of modulation including higher ordered modulations that may include even greater number of constellation points (e.g., 1024 QAM, etc.). Generally, data within a packet may be modulated using a relatively higher-ordered modulation/modulation coding sets (MCSs) than is used for modulating SIG information. Relatively lower-ordered modulation/MCS (e.g., relatively fewer bits per symbol, relatively fewer constellation points per constellation, etc.) may be used for the SIG information to ensure reception by a recipient device (e.g., being relatively more robust, easier to demodulate, decode, etc.). Relatively higher-ordered modulation/MCS (e.g., relatively more bits per symbol, relatively more constellation points per constellation, etc.) may be used for the data payload information of the packet.

FIG. 9E is a diagram illustrating an example 905 of different types of transmission (TX) power used for different sub-carriers within at least one OFDM/A symbol of at least one OFDM/A packet. SIG information that is included only on the even (or odd) sub-carriers may be transmitted using a relatively higher power per sub-carrier then is used to transmit data. On average, the total amount of transmission power across the sub-carriers of the SIG may be approximately the same, but since only half of the sub-carriers within the set are used for modulated SIG information, the transmit power per sub-carrier may be approximately double relative to the transmit power per sub-carrier used for modulated data across all sub-carriers.

FIG. 9F is a diagram illustrating an example 906 of similar transmission (TX) power used for different sub-carriers within at least one OFDM/A symbol of at least one OFDM/A packet. In this diagram, a relatively poor substantially similar transmission power is used for modulated SIG information and also modulated data on the respective sub-carriers.

With respect to FIG. 9E and FIG. 9F, note that other examples may operate such that only a particular integer multiple of sub-carriers are used for SIG information (e.g., every third, every fourth, etc. sub-carriers). In such examples, the power used for modulated SIG information may be scaled appropriately relative to the power used for modulated data information. If every third sub-carrier is used for SIG information, then the power per sub-carrier maybe three times that of data modulated on all sub-carriers; if every fourth sub-carrier is used for SIG information, then the power per sub-carrier maybe four times that of data modulated on all sub-carriers, and so on.

FIG. 9G is a diagram illustrating an example 907 of separate encoding operations to generate different SIGs. In this diagram, first information undergoes encoding using a first encoding process to generate the first at least one SIG, and second information undergoes encoding using a second encoding process to generate the second at least one SIG. Consequently, within a receiver device, the receiver device processes the first at least one SIG to extract the first information and processes the second at least one SIG to extract the second information. These are separate encoding and decoding processes for both the first and second at least one SIGs. A device decodes the first at least one SIG to determine characteristics of the second at least one SIG, and then decodes the second at least one SIG using those determined characteristics.

FIG. 9H is a diagram illustrating another example 908 of separate encoding operations to generate different SIGs. In this diagram, first information undergoes encoding using a first encoding process to generate SIG1/2, and second information undergoes encoding using a second encoding process to generate SIG3. Consequently, within a receiver device, the receiver device processes SIG1/2 to extract the first information and processes SIG3 to extract the second information. These are separate encoding and decoding processes for both SIG1/2 and for SIG3. A device decodes SIG1/2 determine characteristics of SIG3, and then decodes SIG3 using those determined characteristics.

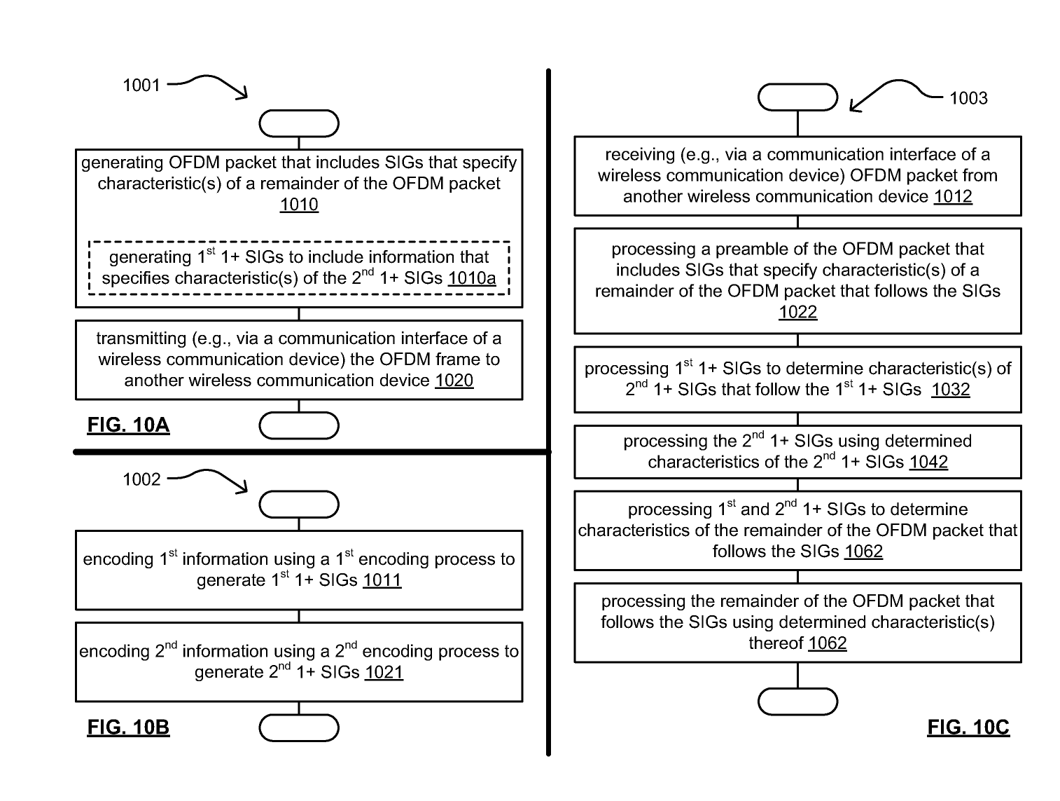

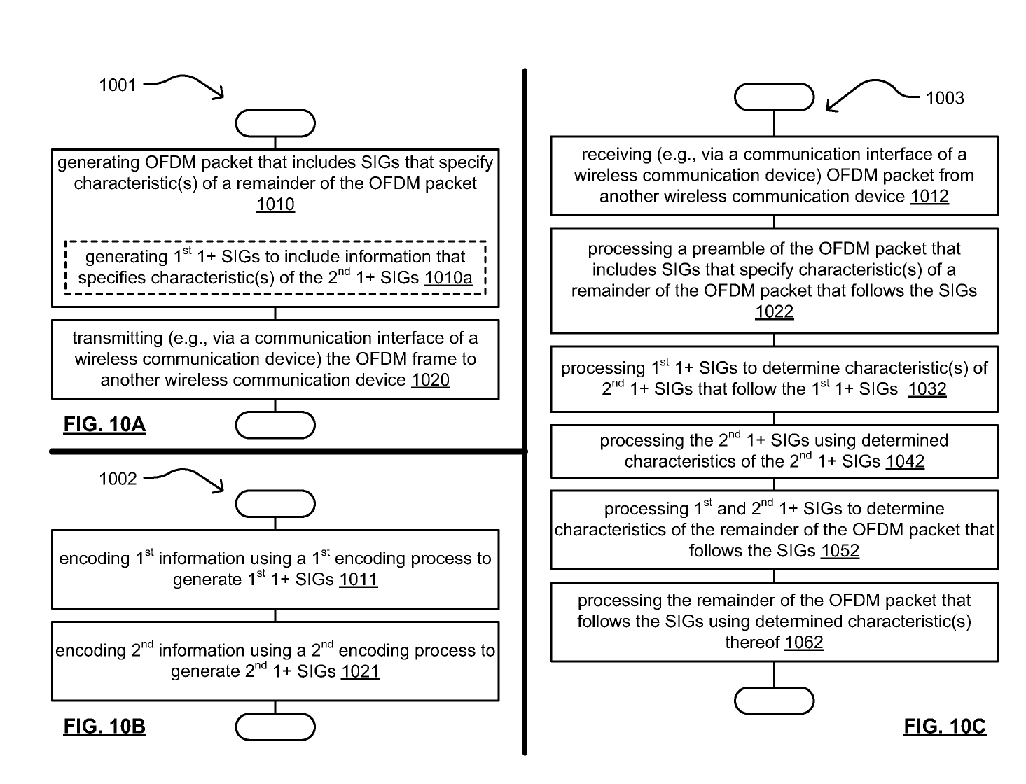

FIG. 10A is a diagram illustrating an embodiment of a method 1001 for execution by at least one wireless communication device. The method 1001 begins by generating a preamble of an OFDM packet that includes a plurality of signal fields (SIGs) that specify a first plurality of characteristics of a remainder of the OFDM packet that follows the plurality of SIG fields (block 1010). In some examples, the first at least one SIG of the plurality of SIGs includes information to specify a second plurality of characteristics of a second at least one SIG of the plurality of SIGs that follows the first at least one SIG of the plurality of SIGs (block 1010a). The method 1001 then operates by transmitting, via a communication interface of the wireless communication device, the OFDM packet to another wireless communication device (block 1020).

FIG. 10B is a diagram illustrating another embodiment of a method 1002 for execution by at least one wireless communication device. The method 1001 begins by encoding first information using a first encoding process to generate the first at least one SIG of the plurality of SIGs (block 1011). The method 1002 continues by encoding second information using a first encoding process to generate the second at least one SIG of the plurality of SIGs (block 1021). In some examples, the first at least one SIG of the plurality of SIGs includes two SIGs and is followed by the second at least one SIG of the plurality of SIGs.

FIG. 10C is a diagram illustrating another embodiment of a method 1003 for execution by at least one wireless communication device. The method 1001 begins by receiving an orthogonal frequency division multiplexing (OFDM) packet from another wireless communication device (block 1012). The method 1003 continues by processing a preamble of the OFDM packet that includes a plurality of signal fields (SIGs) that specify a first plurality of characteristics of a remainder of the OFDM packet that follows the plurality of SIG fields (block 1022). The method 1003 then operates by processing a first at least one SIG of the plurality of SIGs to determine a second plurality of characteristics of a second at least one SIG of the plurality of SIGs that follows the first at least one SIG of the plurality of SIGs (block 1032). The method 1003 continues by processing the second at least one SIG of the plurality of SIGs using the second plurality of characteristics to determine at least one characteristic of the first plurality of characteristics (block 1042).

The method 1003 then operates by processing the first and second at least one SIGs to determine characteristics of the remainder of the OFDM packet that follows the plurality of SIG fields (block 1052). The method 1003 continues by processing the remainder of the OFDM packet that follows the plurality of SIG fields using the first plurality of characteristics (block 1062).

It is noted that the various operations and functions described within various methods herein may be performed within a wireless communication device (e.g., such as by the processor 330, communication interface 320, and memory 340 as described with reference to FIG. 3A) and/or other components therein. Generally, a communication interface and processor in a wireless communication device can perform such operations.

Examples of some components may include one of more baseband processing modules, one or more media access control (MAC) layer components, one or more physical layer (PHY) components, and/or other components, etc. For example, such a processor can perform baseband processing operations and can operate in conjunction with a radio, analog front end (AFE), etc. The processor can generate such signals, packets, frames, and/or equivalents etc. as described herein as well as perform various operations described herein and/or their respective equivalents.

In some embodiments, such a baseband processing module and/or a processing module (which may be implemented in the same device or separate devices) can perform such processing to generate signals for transmission to another wireless communication device using any number of radios and antennae. In some embodiments, such processing is performed cooperatively by a processor in a first device and another processor within a second device. In other embodiments, such processing is performed wholly by a processor within one device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to,” “operably coupled to,” “coupled to,” and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to,” “operable to,” “coupled to,” or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

As may be used herein, the term “compares favorably” or equivalent, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module,” “processing circuit,” “processor,” and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments of an invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples of the invention. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module includes a processing module, a processor, a functional block, hardware, and/or memory that stores operational instructions for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

1. A wireless communication device comprising:
a communication interface; and
a processor, the processor and the communication interface configured to:
generate a preamble of an orthogonal frequency division multiplexing (OFDM) packet that includes a plurality of signal fields (SIGs) that specify a first plurality of characteristics of a remainder of the OFDM packet that follows the plurality of SIG fields, wherein a first at least one SIG of the plurality of SIGs includes information to specify a second plurality of characteristics of a second at least one SIG of the plurality of SIGs that follows the first at least one SIG of the plurality of SIGs; and
transmit the OFDM packet to another wireless communication device.

2. The wireless communication device of claim 1, wherein the second plurality of characteristics includes at least one of:
a size of a guard interval (GI) between the first at least one SIG of the plurality of SIGs and the second at least one SIG of the plurality of SIGs;
a modulation coding set (MCS) used to generate the second at least one SIG of the plurality of SIGs;
a length of the second at least one SIG of the plurality of SIGs; or
a number of OFDM symbols of the second at least one SIG of the plurality of SIGs.

3. The wireless communication device of claim 1, wherein the processor and the communication interface are further configured to:
generate the OFDM packet, wherein the first at least one SIG of the plurality of SIGs is preceded by a first guard interval (GI) having a first GI length, and the second at least one SIG of the plurality of SIGs is preceded by a second GI having a second GI length that is different than the first GI length, wherein the first at least one SIG of the plurality of SIGs has a first SIG length and the second at least one SIG of the plurality of SIGs has a second SIG length that is different than the first SIG length.

4. The wireless communication device of claim 1, wherein the processor and the communication interface are further configured to:
encode first information using a first encoding process to generate the first at least one SIG of the plurality of SIGs; and
encode second information using a first encoding process to generate the second at least one SIG of the plurality of SIGs, wherein the first at least one SIG of the plurality of SIGs includes two SIGs and is followed by the second at least one SIG of the plurality of SIGs.

5. The wireless communication device of claim 1, wherein the processor and the communication interface are further configured to:
generate the preamble of the OFDM packet to include first SIG information of the first at least one SIG of the plurality of SIGs modulated on a contiguous subset of sub-carriers that is centrally located within a set of OFDM sub-carriers and pilot information modulated on at least one other contiguous subset set of sub-carriers that is adjacently located to the contiguous subset of sub-carriers within the set of OFDM sub-carriers; and
generate the preamble of the OFDM packet to include second SIG information of the second at least one SIG of the plurality of SIGs modulated on the set of OFDM sub-carriers.

6. The wireless communication device of claim 1, wherein the processor and the communication interface are further configured to:
generate the preamble of the OFDM packet to include first SIG information of the first at least one SIG of the plurality of SIGs modulated on only even sub-carriers of a contiguous subset of sub-carriers that is centrally located within a set of OFDM sub-carriers and pilot information modulated on only even sub-carriers of at least one other contiguous subset set of sub-carriers that is adjacently located to the contiguous subset of sub-carriers within the set of OFDM sub-carriers; and
generate the preamble of the OFDM packet to include second SIG information of the second at least one SIG of the plurality of SIGs modulated on only even sub-carriers of the set of OFDM sub-carriers.

7. The wireless communication device of claim 1 further comprising:
an access point (AP), wherein the another wireless communication device is a wireless station (STA).

8. The wireless communication device of claim 1 further comprising:
a wireless station (STA), wherein the another wireless communication device is an access point (AP).

9. A wireless communication device comprising:
a communication interface; and
a processor, the processor and communication interface configured to:
receive an orthogonal frequency division multiplexing (OFDM) packet from another wireless communication device;
process a preamble of the OFDM packet that includes a plurality of signal fields (SIGs) that specify a first plurality of characteristics of a remainder of the OFDM packet that follows the plurality of SIG fields;
process a first at least one SIG of the plurality of SIGs to determine a second plurality of characteristics of a second at least one SIG of the plurality of SIGs that follows the first at least one SIG of the plurality of SIGs;
process the second at least one SIG of the plurality of SIGs using the second plurality of characteristics to determine at least one characteristic of the first plurality of characteristics; and
process the remainder of the OFDM packet that follows the plurality of SIG fields using the first plurality of characteristics.

10. The wireless communication device of claim 9, wherein the processor and the communication interface are further configured to:
process the first at least one SIG of the plurality of SIGs to determine at least one other characteristic of the first plurality of characteristics; and
process the remainder of the OFDM packet that follows the plurality of SIG fields using the at least one characteristic of the first plurality of characteristic and the at least one other characteristic of the first plurality of characteristics.

11. The wireless communication device of claim 9, wherein the second plurality of characteristics includes at least one of:
a size of a guard interval (GI) between the first at least one SIG of the plurality of SIGs and the second at least one SIG of the plurality of SIGs;
a modulation coding set (MCS) used to generate the second at least one SIG of the plurality of SIGs;
a length of the second at least one SIG of the plurality of SIGs; or
a number of OFDM symbols of the second at least one SIG of the plurality of SIGs.

12. The wireless communication device of claim 9, wherein the processor and the communication interface are further configured to:
process the first at least one SIG of the plurality of SIGs to determine a guard interval (GI) between the first at least one SIG of the plurality of SIGs and the second at least one SIG of the plurality of SIGs, wherein the GI is determined to be of same length as another GI that precedes the first at least one SIG of the plurality of SIGs or of longer length than the GI.

13. The wireless communication device of claim 9 further comprising:
a wireless station (STA), wherein the another wireless communication device is an access point (AP).

14. A method for execution by a wireless communication device, the method comprising:
generating a preamble of an orthogonal frequency division multiplexing (OFDM) packet that includes a plurality of signal fields (SIGs) that specify a first plurality of characteristics of a remainder of the OFDM packet that follows the plurality of SIG fields, wherein a first at least one SIG of the plurality of SIGs includes information to specify a second plurality of characteristics of a second at least one SIG of the plurality of SIGs that follows the first at least one SIG of the plurality of SIGs; and
transmitting, via a communication interface of the wireless communication device, the OFDM packet to another wireless communication device.

15. The method of claim 14, wherein the second plurality of characteristics includes at least one of:
a size of a guard interval (GI) between the first at least one SIG of the plurality of SIGs and the second at least one SIG of the plurality of SIGs;
a modulation coding set (MCS) used to generate the second at least one SIG of the plurality of SIGs;
a length of the second at least one SIG of the plurality of SIGs; or
a number of OFDM symbols of the second at least one SIG of the plurality of SIGs.

16. The method of claim 14 further comprising:
generating the OFDM packet, wherein the first at least one SIG of the plurality of SIGs is preceded by a first guard interval (GI) having a first GI length, and the second at least one SIG of the plurality of SIGs is preceded by a second GI having a second GI length that is different than the first GI length, wherein the first at least one SIG of the plurality of SIGs has a first SIG length and the second at least one SIG of the plurality of SIGs has a second SIG length that is different than the first SIG length.

17. The method of claim 14 further comprising:
encoding first information using a first encoding process to generate the first at least one SIG of the plurality of SIGs; and
encoding second information using a first encoding process to generate the second at least one SIG of the plurality of SIGs, wherein the first at least one SIG of the plurality of SIGs includes two SIGs and is followed by the second at least one SIG of the plurality of SIGs.

18. The method of claim 14 further comprising:
generating the preamble of the OFDM packet to include first SIG information of the first at least one SIG of the plurality of SIGs modulated on a contiguous subset of sub-carriers that is centrally located within a set of OFDM sub-carriers and pilot information modulated on at least one other contiguous subset set of sub-carriers that is adjacently located to the contiguous subset of sub-carriers within the set of OFDM sub-carriers; and
generating the preamble of the OFDM packet to include second SIG information of the second at least one SIG of the plurality of SIGs modulated on the set of OFDM sub-carriers.

19. The method of claim 14 further comprising:
generating the preamble of the OFDM packet to include first SIG information of the first at least one SIG of the plurality of SIGs modulated on only even sub-carriers of a contiguous subset of sub-carriers that is centrally located within a set of OFDM sub-carriers and pilot information modulated on only even sub-carriers of at least one other contiguous subset set of sub-carriers that is adjacently located to the contiguous subset of sub-carriers within the set of OFDM sub-carriers; and
generating the preamble of the OFDM packet to include second SIG information of the second at least one SIG of the plurality of SIGs modulated on only even sub-carriers of the set of OFDM sub-carriers.

20. The method of claim 14, wherein the wireless communication device is an access point (AP), and the another wireless communication device includes a wireless station (STA).
